(19) United States
(12) Patent Application Publication
(10) Pub. No.: US 2019/0086696 A1
(43) Pub. Date: Mar. 21, 2019

(54) METHOD AND DEVICE FOR ACTUATING AN ACOUSTO-OPTIC ELEMENT

(71) Applicant: Leica Microsystems CMS GmbH, Wetzlar (DE)

(72) Inventors: Patric Mrawek, Hassloch (DE); Lars Friedrich, Weinheim (DE)

(21) Appl. No.: 16/134,999

(22) Filed: Sep. 19, 2018

(30) Foreign Application Priority Data
Sep. 21, 2017 (DE) 10 2017 121 926.9

(51) Int. Cl. G02F 1/11

(52) U.S. Cl. CPC G02F 1/113; G02B 21/16; G02F 1/116

(57) ABSTRACT

A method for actuating an acousto-optic element comprising an acousto-optic crystal and a piezoelectric converter for setting the acousto-optic crystal into mechanical oscillation includes exciting the piezoelectric converter by at least two different frequencies simultaneously. The piezoelectric converter is also excited by at least one mixed frequency from the at least two different frequencies.

### CROSS-REFERENCE TO PRIOR APPLICATION

Priority is claimed to German Patent Application No. DE 10 2017 121 926.9, filed on Sep. 21, 2017, the entire disclosure of which is hereby incorporated by reference herein.

### FIELD

The present invention relates to a method and to a device for actuating an acousto-optic element, and to a microscope comprising a device of this type.

### BACKGROUND

A major challenge in many microscopes, regardless of the method used, is providing excitation light having one or more specified wavelengths. Depending on the type of microscopy method and/or the type of sample, one or more excitation light beams are required, which generally need to have specified spectral properties.

Wavelength-selective elements based on the acousto-optic effect can be used to provide light of this type. Acousto-optic elements of this type generally comprise an acousto-optic crystal that is set into oscillation by means of an acoustic signal generator, which is also referred to as a converter or a transducer. A converter of this type generally comprises a piezoelectric material and two or more electrodes that are in contact with said material. The piezoelectric material is set into oscillation by electrically connecting the electrodes at high frequencies, which are typically in the range of between 10 MHz and 10 GHz, such that an acoustic wave can be produced, which passes through the crystal. Acousto-optic crystals are distinguished by the fact that the sound wave produced changes the optical properties of the crystal.

Examples of acousto-optic elements of this type are acousto-optic tunable filters (AOTF), acousto-optic modulators (AOM), acousto-optic deflectors (AOD), acousto-optic beam splitters (AOBS) and acousto-optic beam mergers (AOBM).

A particular challenge when using acousto-optic elements is the actuation thereof. For example, an optical grating can be produced by means of a sinusoidal actuation signal, which consists in variations in the density of a sound wave passing through a crystal. A specific wavelength of a light beam which matches the actuation frequency is diffracted on said optical grating in the crystal. For each frequency of the applied electrical oscillation, there is a corresponding optical wavelength at which the crystal diffracts light. If a plurality of different actuation frequencies are applied simultaneously, light beams of a plurality of wavelengths can be simultaneously deflected (for example in the case of an AOTF, AOBS, AOBM or AOM), or one wavelength of an incident light beam can be simultaneously deflected into a plurality of light beams in different directions (for example in the case of an AOD).

However, the characteristic curve of a piezoelectric converter has non-negligible saturation behavior, in particular at higher electrical amplitudes, that results in nonlinearity. Sinusoidal oscillations are conventionally used to produce the diffraction grating. Owing to the nonlinearity, when an oscillation of this type is applied to a piezoelectric converter, additional frequencies are produced in addition to the fundamental frequency of the oscillation at multiples of the fundamental frequency. Simultaneously introducing a plurality of oscillations results in further mixed frequencies. “Mixed frequencies” within the meaning of the present document can be understood to mean in particular any linear combination of the fundamental frequencies. When e.g. an AOTF is used in order to select two wavelengths from a continuous spectrum, other undesired wavelengths can appear in the diffracted light beam owing to the nonlinearity of the piezoelectric converter.

A possible solution to this problem is to compensate for the nonlinear characteristic curve of the piezoelectric converter by pre-distorting the original signal applied to the piezoelectric converter such that a linear output signal is obtained.

Pre-distortion of this type allows additional frequency portions to be produced at multiples of the fundamental frequencies and at all mixed frequencies.

However, looking at the structure and the mode of operation of a piezoelectric converter reveals that pre-distortion of this type is disadvantageous. Piezoelectric converters can therefore be considered to be capacitors that absorb only a small portion of real power. A substantial portion of the supplied power is reflected back to the source. This is in particular the case in the frequency range in which conventional acousto-optic crystals are operated.

Matching networks are conventionally introduced between the piezoelectric converter and the signal-generating apparatus. Said networks consist of coils and capacitors and transform the impedance of the piezoelectric converter into an impedance of which the real component is closer to the output impedance of the signal-generating apparatus than the impedance of the piezoelectric converter in the absence of a matching network. Impedance matching of this type is possible only in a limited frequency range. In conventional acousto-optic crystals, approximately one octave is possible.

This shows that the aforementioned pre-distortion method is impeded by the matching network. The additional frequencies produced by the pre-distortion are outside the bandwidth of the matching network and cannot reach the piezoelectric converter.

### SUMMARY

In an embodiment, the present invention provides a method for actuating an acousto-optic element comprising an acousto-optic crystal and a piezoelectric converter for setting the acousto-optic crystal into mechanical oscillation. The piezoelectric converter is excited by at least two different frequencies simultaneously. The piezoelectric converter is also excited by at least one mixed frequency from the at least two different frequencies.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a graph showing a characteristic curve of a piezoelectric converter;

FIG. 2 is a schematic view of a light beam having a continuous spectrum being deflected on an acousto-optic filter;

FIG. 3 is a schematic view of a light beam having a continuous spectrum being deflected on an acousto-optic filter, in which a method according to the invention is being carried out;

FIG. 4 is a schematic view of an embodiment of a device for actuating an acousto-optic element.

### DETAILED DESCRIPTION

Embodiments of the present invention provide for actuating a piezoelectric converter in an acousto-optic element such that deflection of undesired light wavelengths is reduced or prevented completely.

According to embodiments of the invention, a method and a device for actuating an acousto-optic element comprising a piezoelectric converter and an acousto-optic crystal are provided, together with a microscope comprising a device of this type.

An embodiment of the invention is based on the measure whereby, when the piezoelectric converter is excited by at least two different frequencies simultaneously, said converter is also excited by at least one mixed frequency from the at least two different frequencies. Said additional mixed frequency from the at least two different frequencies allows an oscillation at the same mixed frequency at which the crystal is excited owing to the nonlinearity to be compensated for and reduced in a targeted manner. The piezoelectric converter is preferably excited by the at least one mixed frequency from the at least two different frequencies such that an oscillation at the same mixed frequency at which the crystal is excited owing to the nonlinearity is reduced or eliminated completely.

In contrast to pre-distortion of the original signal, the method according to an embodiment of the invention merely induces an oscillation at the at least one mixed frequency in a targeted manner. Said mixed frequencies, which consist of linear combinations of the at least two frequencies and are very close to the fundamental frequencies, are the most problematic mixed frequencies because they diffract light in the immediate wavelength range of the fundamental frequencies.

An embodiment of the invention is in particular based on compensating for said mixed frequencies in the immediate frequency range of the fundamental frequencies by inputting, in a targeted manner, exactly these mixed frequencies together with the correct phase position.

In an advantageous embodiment, a matching network is arranged between the piezoelectric converter and a signal-generating apparatus and transforms an impedance of the piezoelectric converter into an impedance of which the real component is closer to an output impedance of the signal-generating apparatus than the real component of the impedance of the piezoelectric converter in the absence of a matching network. This is advantageous because a higher real power can be introduced into the piezoelectric converter in this way.

The matching network expediently comprises at least one inductor and/or at least one capacitor. In this way, the impedance can be advantageously transformed as desired.

The at least one mixed frequency is also preferably within a range of between half the frequency of the smallest of the at least two frequencies and double the frequency of the largest of the at least two frequencies (i.e. one octave above and below, respectively). In this way, the at least one mixed frequency is within the bandwidth of an advantageous matching network.

In an advantageous embodiment, an amplitude of the excitation having the at least one mixed frequency is selected such that said amplitude corresponds precisely or substantially to an amplitude of an oscillation at the same at least one mixed frequency at which the piezoelectric converter is excited owing to nonlinearity. The oscillation at the same at least one mixed frequency is thus advantageously largely compensated for at the corresponding phase position. In this case, “substantially” preferably means that the amplitude of the excitation of the at least one mixed frequency corresponds to between 95% and 105% of the amplitude of an oscillation at the same at least one mixed frequency at which the piezoelectric converter is excited owing to nonlinearity.

A phase of the excitation having the at least one mixed frequency is expediently selected such that at least one interfering frequency portion is compensated for, and/or such that said phase is precisely or substantially in phase opposition to an oscillation at the same at least one mixed frequency at which the piezoelectric converter is excited owing to nonlinearity. This is advantageous because, in this way, the excitation having the at least one mixed frequency precisely compensates for the oscillation at the same at least one mixed frequency at which the piezoelectric converter is excited owing to nonlinearity.

In another advantageous embodiment, the piezoelectric converter is excited by more than one mixed frequency from the at least two different frequencies. Depending on how close the at least two different frequencies are to one another, and on how many of the at least two different frequencies are present, a plurality of mixed frequencies may be relevant, as linear combinations from the at least two frequencies that are very close to said fundamental frequencies are particularly relevant because said combinations diffract light in the immediate wavelength range of the fundamental frequencies.

The piezoelectric converter is preferably excited by all the mixed frequencies within a range of between half of a lowest frequency of the at least two different frequencies and double a highest frequency of the at least two frequencies. This should not be considered limiting. Another selection of the mixed frequencies is therefore also conceivable. However, mixed frequencies at a maximum distance of one octave from the at least two frequencies are within a bandwidth of a matching network.

The acousto-optic element is preferably selected from an acousto-optic tunable filter, an acousto-optic modulator (AOM), an acousto-optic deflector (AOD), an acousto-optic beam splitter (AOBS) and an acousto-optic beam merger (AOBM). An acousto-optic tunable filter (AOTF) in particular is advantageously suitable for the method according to the invention.

Further advantages and embodiments of the invention can be found in the description and in the accompanying drawings.

The aforementioned features and the features described in the following can be used not only in the stated combination, but also in other combinations, or alone, without departing from the scope of the present invention.

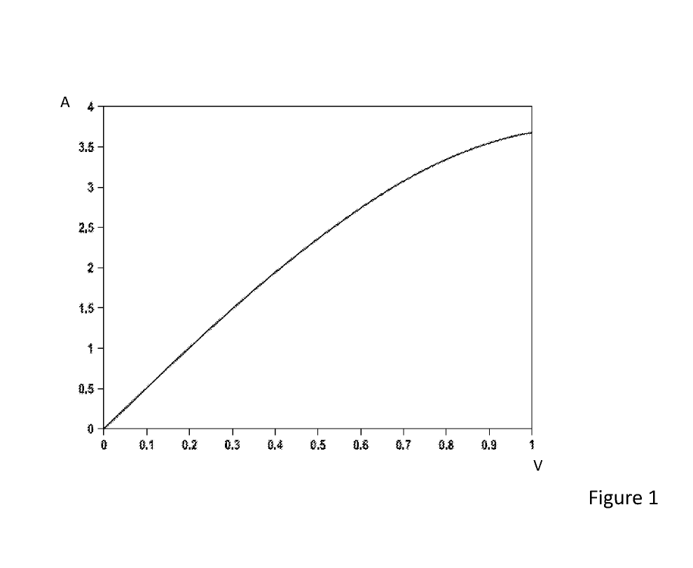

FIG. 1 is a graph showing a typical characteristic curve of a piezoelectric converter. For example, a sound amplitude A coupled into the crystal is plotted on the vertical axis against an electrical voltage V applied to the piezoelectric converter on the horizontal axis. It can be seen that the graph is initially linear, but then becomes saturated.

Mathematically, the saturation behavior of a piezoelectric converter can be described using e.g. a polynomial having the following form:

f(x)=a·x·b·x²+c·x³

In this case, the coefficient a is the linear amplification or attenuation, and b and c define the saturation behavior.

Sinusoidal oscillations are conventionally used to produce the diffraction grating. If an oscillation of this type is applied to the aforementioned characteristic curve, additional frequencies will occur in addition to the fundamental frequency of the oscillation at multiples of the fundamental frequency.

If a plurality of oscillations (e.g. having the frequencies ω₁ and ω₂) are introduced, further mixed products will occur, for example the known frequencies 2ω₁−ω₂ and 2ω₂−ω₁.

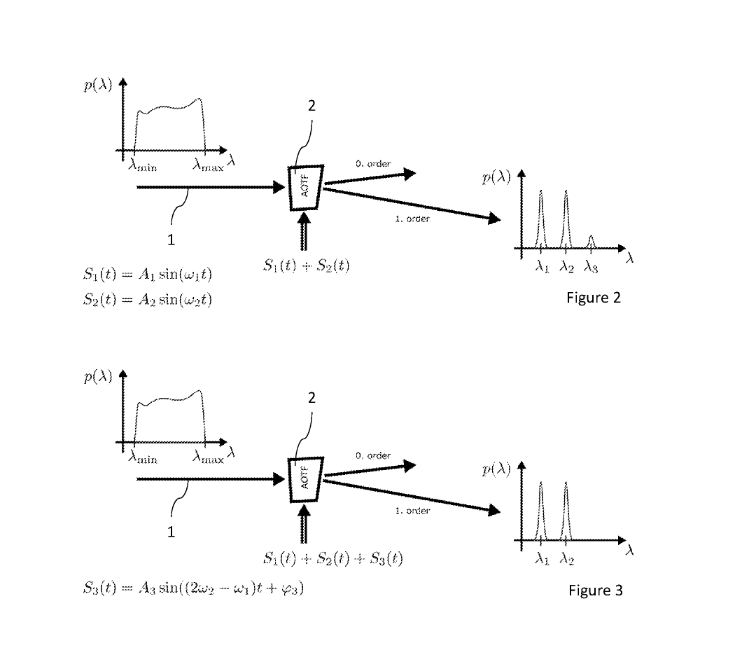

FIG. 2 is a schematic view of a light beam having a continuous spectrum being deflected on an acousto-optic filter.

A graph in the upper left corner of FIG. 2 shows, by way of example, the intensity distribution of the spectrum of the inbound light beam 1. Said light beam has a continuous spectrum between λₘᵢₙ and λₘₐₓ. Said light beam is oriented towards an acousto-optic filter AOTF 2 of which the acousto-optic crystal is set into oscillation by means of a piezoelectric converter. In this process, said light beam is excited by a combination of two signals, namely S₁(t)=A₁ sin(ω₁t) having the frequency ω₁ and S₂(t)=λ₂ sin(ω₂t) having the frequency ω₂, in order to select the two wavelengths λ₁ and λ₂ from the continuous spectrum between λₘᵢₙ and λₘₐₓ. However, owing to the nonlinearity of the piezoelectric converter, the undesired wavelength λ₃ also appears in the diffracted light beam.

This is a result of problematic mixed frequencies. The nonlinearity therefore also induces oscillations at mixed frequencies of the two fundamental frequencies, e.g. 2ω₁−ω₂ or 3ω₂−2ω₁, etc. Said mixed frequencies are very close to the fundamental frequencies and therefore diffract light in the immediate wavelength range of the fundamental frequencies, in this case light having the wavelength λ₃.

In FIG. 3, which shows a preferred embodiment of the invention, in addition to the combination of the two signals S₁(t)=A₁ sin(ω₁t) having the frequency ω₁ and S₂(t)=λ₂ sin(ω₂t) having the frequency ω₂, the piezoelectric converter is also excited by a signal S₃(t)=λ₃ sin((2ω₂−ω₁) t+ϕ₃) having the frequency 2ω₂−ω₁ and the phase ϕ₃.

Said additional signal advantageously results not in amplification of the light output at λ₃, but in reduction or even elimination if the amplitude λ₃ and the phase position ϕ₃ are selected correctly. This could be accomplished, for example, by means of individual calibration with regard to the characteristic curve of the individual matching network, the transducer and the crystal, the use of suitable actuation software being a possibility since calibration may be necessary at a plurality of grid points (combinations of useful frequencies and associated amplitudes and phases). It is, moreover, also conceivable that compensation is not necessary at every frequency constellation. Depending on the frequency position, the amplitudes of the interfering frequencies vary considerably. In this case, compensation can be limited to mixed frequencies which prove to be particularly disruptive.

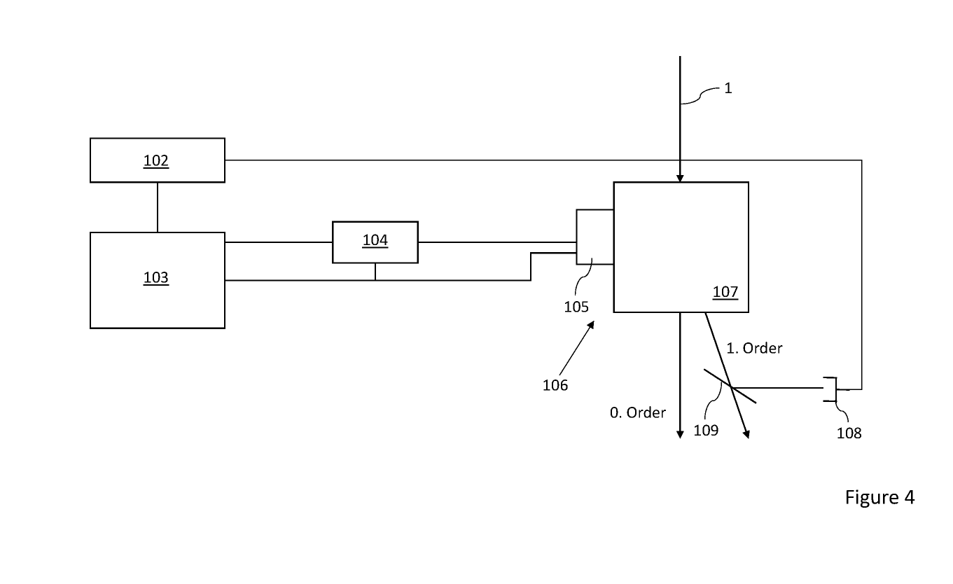

FIG. 4 is a schematic view of an embodiment of a device for actuating an acousto-optic element according to a preferred embodiment of the invention. The device comprises a signal generator 103 and a control apparatus 102 which actuates the signal generator 103. The signal generator 103 emits a signal to an acousto-optic element 106 that comprises a piezoelectric converter 105 and an acousto-optic crystal 107. A matching network 104 that matches an impedance of the piezoelectric converter 105 to an impedance of the signal generator 103 is connected upstream of the piezoelectric converter 105.

In addition to conventionally actuating the piezoelectric converter 105 by means of e.g. a combination of sinusoidal signals, the control apparatus 102 is designed for outputting corresponding signals having mixed frequencies in order to compensate for the excitations caused by nonlinearity.

In principle, optical feedback can be provided if automatically running method steps of the method according to the invention are carried out in the control apparatus. The detector 108, for example, which detects or analyzes at least one property of at least one portion of the light that passes through the acousto-optic crystal 107, could be provided for this purpose. Specifically, a beam splitter 109 that deflects a portion of the light that passes through the acousto-optic crystal 107 towards the detector is provided to this end. The detector can be a photodiode and/or a spectrometer.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for actuating an acousto-optic element comprising an acousto-optic crystal and a piezoelectric converter for setting the acousto-optic crystal into mechanical oscillation, the method comprising:
exciting the piezoelectric converter by at least two different frequencies simultaneously; and
exciting the piezoelectric converter also by at least one mixed frequency from the at least two different frequencies.

2. The method according to claim 1, wherein an amplitude of the excitation having the at least one mixed frequency is selected such that the amplitude precisely or substantially corresponds to an amplitude of an oscillation at the same at least one mixed frequency at which the piezoelectric converter is excited owing to nonlinearity.

3. The method according to claim 1, wherein a phase of the excitation having the at least one mixed frequency is selected such that at least one interfering frequency portion is compensated for, and/or such that the phase is precisely or substantially in phase opposition to an oscillation at the same at least one mixed frequency at which the piezoelectric converter is excited owing to nonlinearity.

4. The method according to claim 1, wherein the piezoelectric converter is excited by more than one mixed frequency from the at least two different frequencies.

5. The method according to claim 1, wherein the piezoelectric converter is excited by all the mixed frequencies within the range of between half of a lowest frequency of the at least two different frequencies and double a highest frequency of the at least two frequencies.

6. The method according to claim 1, wherein the acousto-optic element is selected from an acousto-optic tunable filter, an acousto-optic modulator, an acousto-optic deflector, an acousto-optic beam splitter and an acousto-optic beam merger.

7. A device for actuating an acousto-optic element comprising an acousto-optic crystal and a piezoelectric converter for setting the acousto-optic crystal into mechanical oscillation, the device comprising:
at least one signal-generating apparatus configured to excite the piezoelectric converter by at least two frequencies; and
at least one control apparatus configured to actuate the signal-generating apparatus such that the piezoelectric converter is also excited by at least one mixed frequency from the at least two different frequencies.

8. The device according to claim 7, wherein a matching network is arranged between the piezoelectric converter and the signal-generating apparatus and is configured to transform an impedance of the piezoelectric converter into an impedance of which the real component is closer to an output impedance of the signal-generating apparatus than the real component of the impedance of the piezoelectric converter in the absence of a matching network.

9. The device according to claim 8, wherein the matching network comprises at least one inductor and/or at least one capacitor.

10. A microscope comprising the device according to claim 7.
